(19) United States
(12) Patent Application Publication
(10) Pub. No.: US 2026/0299459 A1
(43) Pub. Date: Oct. 1, 2026

(54) OPTICAL SCANNING DEVICE AND IMAGE FORMING APPARATUS

(71) Applicant: KONICA MINOLTA, INC., Tokyo (JP)

(72) Inventors: Takaki UEMURA, Seto-shi (JP); Yoshikazu WATANABE, Toyohashi-shi (JP); Hiroshi EGUCHI, Toyohashi-shi (JP); Masayuki IIJIMA, Okazaki-shi (JP); Haruki NAKAMURA, Toyokawa-shi (JP)

(73) Assignee: KONICA MINOLTA, INC., Tokyo (JP)

(21) Appl. No.: 19/571,328

(22) Filed: Mar. 18, 2026

(30) Foreign Application Priority Data
Mar. 27, 2025 (JP) 2025-053438

(51) Int. Cl. G03G 15/041; B41J 2/44; B41J 2/47; G03G 15/00; G03G 15/01; G03G 15/04; G03G 21/16

(52) U.S. Cl. CPC G03G 15/0415; B41J 2/44; B41J 2/471; G03G 15/04036; G03G 15/55; G03G 21/1633; G03G 15/011; G03G 15/0189; G03G 2221/1648

(57) ABSTRACT

An optical scanning device includes a casing that seals an inside thereof, a light source provided inside the casing, and an optical scanner that is provided inside the casing and scans the light emitted from the light source. The light emitted from the light source passes through an external space of the casing, and the light entering the inside of the casing again from the external space is guided to the optical scanner.

### CROSS REFERENCE TO RELATED APPLICATIONS

The present application is based on Japanese Patent Application No. 2025-053438 filed on Mar. 27, 2025, the contents of which are incorporated herein by reference.

### BACKGROUND OF THE INVENTION

### Technical Field

The present invention relates to an optical scanning device and an image forming apparatus including the same.

### Description of Related Art

An image forming apparatus that forms an image by electrophotographic method includes an optical scanning device for exposing a photoreceptor. The optical scanning device includes, as optical components, a light source that emits a light beam and a scanning member that deflects the light beam to perform scanning. In this type of optical scanning device, the amount of light for exposing the surface of the photoreceptor varies according to the processing speed of the image forming apparatus. Therefore, a conventional optical scanning device is generally provided with optical components corresponding to the processing speed of the image forming apparatus.

However, in recent years, an optical scanning device that has been mounted in an image forming apparatus may be mounted in another image forming apparatus during remanufacturing, refurbishment, or the like. At this time, the optical scanning device may be mounted in an image forming apparatus having a processing speed different from a previous processing speed. In a case where the optical scanning device is mounted in an image forming apparatus having a different processing speed from a previous processing speed, it is necessary to replace an optical component such as a light source mounted in the optical scanning device.

However, optical components mounted in the optical scanning device are housed in a sealed casing for dust prevention. Therefore, when the optical component is replaced, the work must be performed in a clean room, and the replacement cannot be easily performed.

On the other hand, an optical scanning device including a transmittance adjustment device has been proposed in order that the optical scanning device can be used without replacing optical components in image forming apparatuses having different processing speeds. Such an optical scanning device is disclosed in, for example, Japanese Unexamined Patent Publication No. JP2012-11706A. The optical scanning device disclosed in Japanese Unexamined Patent Publication No. JP2012-11706A includes a transmittance adjusting element that can move forward and backward with respect to an optical path of light emitted from light sources. That is, the optical scanning device includes a solenoid that slides the transmittance adjusting element between an insertion position in the optical path and a retraction position outside the optical path. The optical scanning device can insert the transmittance adjusting element into an optical path by driving the solenoid to attenuate the amount of light from the light source.

However, when the slidably movable transmittance adjusting element and the solenoid are mounted on the optical scanning device, a device configuration becomes complicated. As a result, there is a problem that the size of the optical scanning device increases. In addition, there is also a problem that an apparatus cost is increased.

### SUMMARY OF THE INVENTION

The present invention has been devised in order to solve the above-described conventional problems. That is, an object of the present invention is to provide an optical scanning device that can be applied to image forming apparatuses having different processing speeds with simple operation that does not complicate the device configuration and does not require a clean room, and an image forming apparatus including the same.

In order to achieve the above object, an aspect of the present invention is directed to an optical scanning device. According to this aspect, an optical scanning device includes: a casing that seals an inside thereof; a light source provided inside the casing; and an optical scanner that is provided inside the casing and scans the light emitted from the light source, wherein the light emitted from the light source passes through an external space of the casing, and the light entering the inside of the casing again from the external space is guided to the optical scanner.

### BRIEF DESCRIPTION OF THE DRAWINGS

The advantages and features provided by one or more embodiments of the invention will become more fully understood from the detailed description given herein below and the appended drawings which are given by way of illustration only, and thus are not intended as a definition of the limits of the present invention.

FIG. 1 is a diagram illustrating an example of the configuration of an image forming apparatus;

FIG. 2 is a plan view illustrating a configuration of an optical scanning device;

FIG. 3 is an A-A end view of the optical scanning device shown in FIG. 2;

FIG. 4A, FIG. 4B, and FIG. 4C are views schematically showing optical paths from the light sources to the scanning member inside the casing.

FIG. 5 is a diagram illustrating a detection sensor provided in proximity to the optical scanning device;

FIG. 6 is a flowchart illustrating an example of a processing procedure by a controller; and

FIG. 7 is a plan view illustrating a modification example of the optical scanning device.

### DETAILED DESCRIPTION OF EMBODIMENTS

Hereinafter, one or more embodiments of the present invention will be described with reference to the drawings. However, the scope of the invention is not limited to the disclosed embodiments. Note that in the embodiments described below, common elements are denoted by the same reference signs, and redundant description thereof is omitted.

### Example of Configuration of Image Forming Apparatus 1

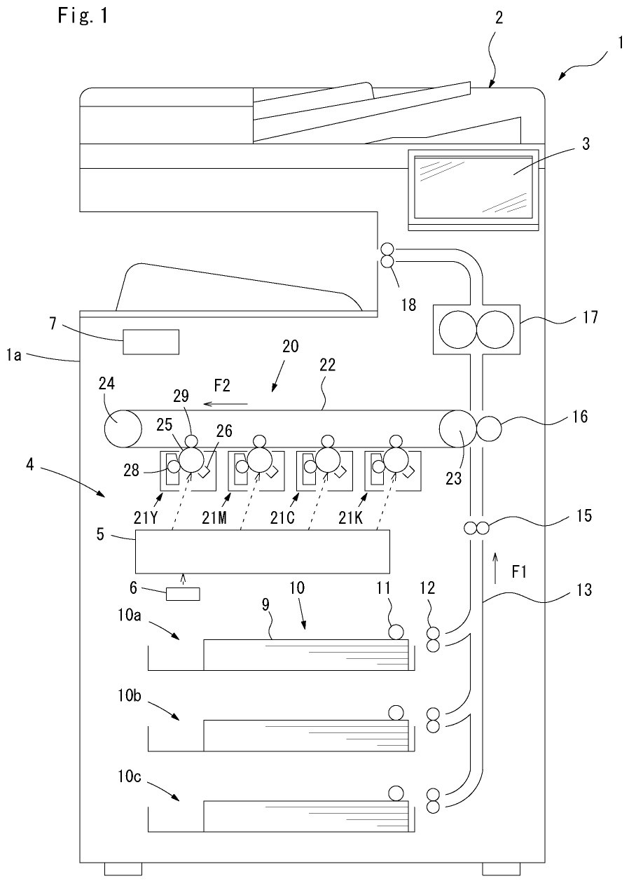

FIG. 1 illustrates an example of the configuration of an image forming apparatus 1 according to an embodiment of the present invention. The image forming apparatus 1 is configured as a MFP (Multi-Function Peripheral), and has a plurality of functions such as a scan function, a print function, and a copy function.

The image forming apparatus 1 includes a scanner unit 2 at an upper part of the apparatus body 1a and a printer unit 4 at a lower part of the apparatus body 1a. The scanner unit 2 operates when a job related to the scan function or the copy function is executed, and optically reads an image of a document set by a user to generate image data. The printer unit 4 operates when a job related to the print function or the copy function is executed, and forms and outputs an image on a sheet 9 such as a print sheet. The printer unit 4 of the present embodiment forms an image on the sheet 9 by an electrophotographic method.

In addition, the image forming apparatus 1 includes an operation panel 3 which can be operated by a user on the front side of the apparatus body 1a. The operation panel 3 includes a display part that displays various screens that can be operated by the user, and an operation part that receives an operation by the user. The display part is configured by, for example, a color liquid crystal display. The operation part includes, for example, a touch screen disposed on a screen of the display part. That is, the operation panel 3 is a user interface for a user who uses the image forming apparatus 1.

FIG. 1 shows an internal structure of the printer unit 4. As shown in FIG. 1, the printer unit 4 includes a sheet feed and conveyance section 10 and an image forming section 20. Inside the printer unit 4, a controller 7 is provided which comprehensively controls the operation of the image forming apparatus 1. The controller 7 includes a hardware processor. The hardware processor reads and executes a computer-readable program, whereby the controller 7 controls the operation of each unit. For example, controller 7 controls execution of a job in image forming apparatus 1.

The sheet feed and conveyance section 10 feeds the sheet 9 from any one of the plurality of sheet feed trays 10a, 10b, and 10c, and conveys the sheet 9 along a conveyance path 13 formed inside the printer unit 4. Each of the sheet feed trays 10a, 10b, and 10c accommodates different types of sheets 9 or the same type of sheets 9. Each of the sheet feed trays 10a, 10b, and 10c is provided with a pickup roller 11 and a sheet feed roller 12. The sheet feed and conveyance section 10 drives a pickup roller 11 and a sheet feed roller 12 provided in one sheet feed tray designated by the user, and feeds the sheet 9 toward a conveyance path 13. The sheet feed and conveyance section 10 conveys the sheet 9 sent to the conveyance path 13 along the direction of the arrow F1.

The conveyance path 13 is provided with a timing roller 15, a secondary transfer roller 16, a fixing section 17, and a discharge roller 18.

The timing roller 15 is composed of a pair of rollers. The timing roller 15 is a roller that adjusts the timing at which the sheet 9 is fed to the secondary transfer position by the secondary transfer roller 16. When a leading end of the sheet 9 fed from one of the sheet feed trays 10a, 10b, and 10c reaches a position of the timing roller 15, the sheet feed and conveyance section 10 temporarily stops conveyance of the sheet 9. The sheet feed and conveyance section 10 then drives the timing roller 15 in accordance with the timing at which the image primarily transferred onto the intermediate transfer belt 22 in the image forming section 20 is conveyed to the secondary transfer position, to convey the sheet 9 toward the secondary transfer roller 16.

When the sheet 9 fed from the timing roller 15 passes through a secondary transfer position by the secondary transfer roller 16, an image is secondarily transferred onto the sheet 9. The sheet 9 on which the image has been secondarily transferred is conveyed to the fixing section 17.

The image forming section 20 includes image forming units 21Y, 21M, 21C, and 21K corresponding to respective colors of yellow (Y), magenta (M), cyan (C), and black (K), an intermediate transfer belt 22, an optical scanning device 5, and a detection sensor 6. The intermediate transfer belt 22 is placed above the image forming units 21Y, 21M, 21C, and 21K. The optical scanning device 5 is installed below the image forming units 21Y, 21M, 21C, and 21K. The detection sensor 6 is installed at a position close to the optical scanning device 5.

The image forming unit 21Y is a unit that forms a Y color image. The image forming unit 21Y includes a cylindrical photoreceptor 25, a charging device 26, and a developing device 28. The photoreceptor 25 has a photosensitive layer on its cylindrical outer peripheral surface, and rotates in a predetermined direction (clockwise direction). The charging device 26 and the developing device 28 are arranged around the photoreceptor 25. The charging device 26 charges the surface of the photoreceptor 25 to a predetermined charge.

The optical scanning device 5 exposes the surface of the photoreceptor 25 charged to predetermined charge by the charging device 26 from below the image forming unit 21Y to form electrostatic latent image on the surface of the photoreceptor 25. That is, the optical scanning device 5 repeatedly irradiates the surface of the rotating photoreceptor 25 with scanning light for scanning in a main scanning direction parallel to the axis direction of the photoreceptor 25 on the basis of image data of Y color, to form an electrostatic latent image.

The developing device 28 is arranged on a downstream side of an exposure position by the optical scanning device 5 in a rotation direction of the photoreceptor 25. The developing device 28 supplies a developer containing toner to the surface of the photoreceptor 25 exposed by the optical scanning device 5, and develops the electrostatic latent image with the toner. Thus, an image (toner image) corresponding to the image data of the color Y is formed on the surface of the photoreceptor 25.

The other image forming units 21M, 21C, and 21K have the same configuration as the image forming unit 21Y, and are different only in the color of toner to be supplied to the photoreceptors 25. That is, the plurality of image forming units 21Y, 21M, 21C, and 21K having the same configuration are horizontally arranged below the intermediate transfer belt 22 at predetermined intervals. The optical scanning device 5 exposes the surfaces of the photoreceptors 25 provided in the plurality of image forming units 21Y, 21M, 21C, and 21K to form electrostatic latent images corresponding to the respective colors. The image forming units 21Y, 21M, 21C, and 21K develop the electrostatic latent images formed on the surfaces of the photoreceptors 25 to form images (toner images) in the respective colors Y, M, C, and K.

The intermediate transfer belt 22 is an endless belt disposed horizontally above the image forming units 21Y, 21M, 21C, and 21K. The intermediate transfer belt 22 is wound around a driving roller 23 provided at a position facing the secondary transfer roller 16 and a driven roller 24 provided at a position separated from the driving roller 23 by a predetermined interval in the horizontal direction. As the driving roller 23 is rotationally driven in the counterclockwise direction, the intermediate transfer belt 22 circulates in a direction indicated by an arrow F2. The intermediate transfer belt 22 contacts the secondary transfer roller 16 at the position of the driving roller 23.

Inside the intermediate transfer belt 22, primary transfer rollers 29 are provided at positions opposing the image forming units 21Y, 21M, 21C, and 21K, respectively. A predetermined voltage is applied to the primary transfer rollers 29 with the intermediate transfer belt 22 pressed against the photoreceptor 25 in each of the image forming units 21Y, 21M, 21C, and 21K, such that the images (toner images) formed on the photoreceptors 25 are primarily transferred onto the intermediate transfer belt 22. The respective image forming units 21Y, 21M, 21C, and 21K primarily transfer the respective images of Y, M, C, and K onto the intermediate transfer belt 22 while sequentially superimposing the images. Thus, a color image is formed on the surface of the intermediate transfer belt 22. The image transferred to the intermediate transfer belt 22 is secondarily transferred to the sheet 9 at a position of the secondary transfer roller 16.

The fixing section 17 fixes the image on the sheet 9 by performing a heating process and a pressing process on the sheet 9 on which the image is formed. For example, the fixing section 17 includes a heating roller and a pressure roller, and performs heating processing and pressure processing on the sheet 9 in a nip portion between the heating roller and the pressure roller. The sheet 9 on which the image is fixed in the fixing section 17 is discharged to a sheet ejection tray formed in an upper portion of the printer unit 4 by a discharge roller 18.

In the image forming apparatus 1 as described above, the optical scanning device 5 is detachable from the printer unit 4. Therefore, the optical scanning device 5 may be detached from one image forming apparatus 1 and then attached to another image forming apparatus 1 in remanufacturing, refurbishment, or the like. At this time, the optical scanning device 5 may be mounted in the image forming apparatus 1 having a processing speed different from a previous processing speed.

For example, since the image forming apparatus 1 having a high processing speed prints a large number of sheets per unit time, the rotation speed of the photoreceptor 25 increases. Therefore, when the processing speed is high, it is necessary to increase the amount of light in order to prevent insufficient exposure when the optical scanning device 5 exposes the photoreceptor 25. In contrast, the image forming apparatus 1 having a low processing speed prints a small number of sheets per unit time, and thus the rotation speed of the photoreceptor 25 decreases. Therefore, in a case where the processing speed is low, it is necessary to reduce the amount of light in order to prevent overexposure when the optical scanning device 5 exposes the photoreceptor 25.

The optical scanning device 5 of the present embodiment is configured to be able to easily adjust the amount of light according to the processing speed of the image forming apparatus 1. Hereinafter, the optical scanning device 5 of the present embodiment will be described in detail.

### Optical Scanning Device 5

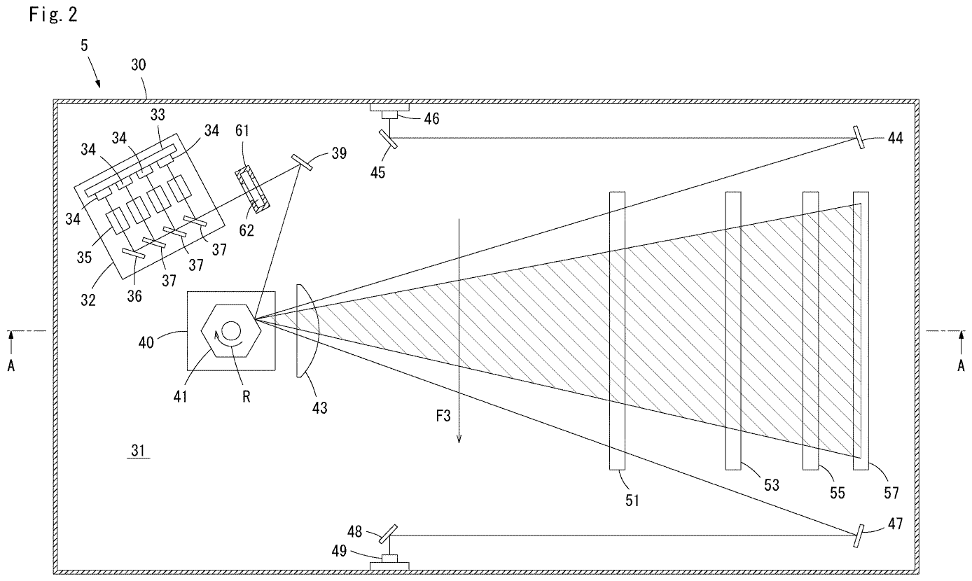

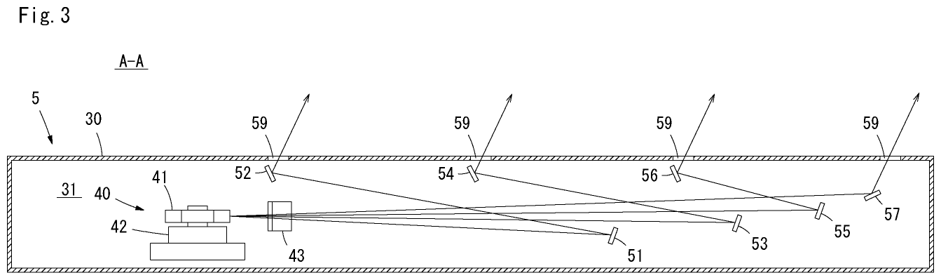

FIG. 2 is a plan view illustrating a configuration of the optical scanning device 5. FIG. 3 is an A-A end face view of the optical scanning device 5 illustrated in FIG. 2. In the optical scanning device 5, optical components for exposing the photoreceptor 25 are mounted in an internal space 31 of a casing 30 whose inside is sealed. The optical scanning device 5 includes, as optical components, a light source unit 32, a mirror 39, a scanning member (optical scanner) 40, an fθ (f-theta) lens 43, mirrors 44, 45, 47, and 48, optical sensors 46 and 49, and mirrors 51 to 57.

The light source unit 32 emit light beams for forming electrostatic latent images to the photoreceptor 25 provided in the image forming units 21Y, 21M, 21C, and 21K, respectively. The light source unit 32 includes four light sources 34 mounted on a substrate 33. Four light sources 34 individually emit light to expose the respective photoreceptor 25 of the image forming units 21Y, 21M, 21C, and 21K. For example, the light source 34 is formed of a laser light source, an LED light source, or the like. Light emitted from the light source 34 is turned into parallel light by the collimator lens 35, and after being reflected off the mirrors 36 and 37, travels in substantially the same direction. For example, the mirrors 37 are arranged at different levels so as not to block the light reflected by the mirrors 36 and 37. The mirrors 37 may be configured as half mirrors.

In color printing, a total of four light beams corresponding to the respective colors of Y, M, C, and K are emitted from the light source unit 32. Light emitted from the light source unit 32 is directed toward the mirror 39, is reflected off the mirror 39, and is then guided to the scanning member 40.

The scanning member 40 includes a polygon mirror 41 and a polygon motor 42 that rotates the polygon mirror 41. The polygon mirror 41 is a polyhedron mirror in which total reflection mirrors are formed on an outer peripheral surface of a polygonal prism shape. The light guided from the mirror 39 is incident on the polygon mirror 41. The polygon mirror 41 is rotated at a high speed in one direction by the polygon motor 42 to deflect light in the main scanning direction F3. The deflected light proceeds to the fθ lens 43.

The fθ lens 43 corrects the light incident from the polygon mirror 41 so that the light beam scans at a constant speed in the main scanning direction F3. The light that has passed through the fθ lens 43 is reflected by the mirrors 51 to 57, passes through the transparent plate 59 provided on the upper surface of the casing 30, and is emitted to the outside of the casing 30. Then, the light beams emitted from the casing 30 are guided to the respective photoreceptors 25 of the image forming units 21Y, 21M, 21C, and 21K to expose the surfaces of the photoreceptors 25.

The light reflected by the polygon mirror 41 is reflected by the mirrors 44 and 47 arranged outside the mirrors 51, 53, 55, and 57.

The mirror 44 is disposed, for example, near an end portion of the mirror 57 on the upstream side in the main scanning direction F3. The light reflected by the mirror 44 is reflected again by the mirror 45 and is guided to the optical sensor 46. That is, light is incident on the optical sensor 46 at a timing at which scanning in the main scanning direction F3 is started. Therefore, the detection signal from the optical sensor 46 is used as a SOS (start of scan) signal to synchronize the start of main scanning of each line.

The mirror 47 is disposed, for example, near an end portion of the mirror 57 on the downstream side in the main scanning direction F3. The light reflected by the mirror 47 is reflected again by the mirror 48 and is guided to the optical sensor 49. That is, light enters the optical sensor 49 at the timing when scanning in the main scanning direction F3 ends. Therefore, the detection signal by the optical sensor 49 is used as an EOS (End of Scan) signal to synchronize the end of the main scanning of each line.

As illustrated in FIG. 2, the optical scanning device 5 configured as described above is configured such that, in an optical path along which light emitted from the light source 34 enters the scanning member 40, the light passes through the external space 62 isolated from the internal space 31 of the casing 30. The external space 62 is formed in a region surrounded by a partition wall 61 erected inside the casing 30. For example, the partition wall 61 is formed in a manner such as to stand in a rectangular tube shape in a plan view and close an upper end opening of the rectangular tube shape. Thus, an external space 62 isolated from the internal space 31 of the casing 30 is formed inside the partition wall 61 erected in the shape of a rectangular tube.

FIG. 2 shows an example in which a partition wall 61 is erected in the optical path from the light source 34 to the mirror 39 to form an external space 62. However, the embodiment is not limited thereto. For example, the partition wall 61 may be erected in the optical path from the mirror 39 to the scanning member 40, and the external space 62 surrounded by the partition wall 61 may be formed.

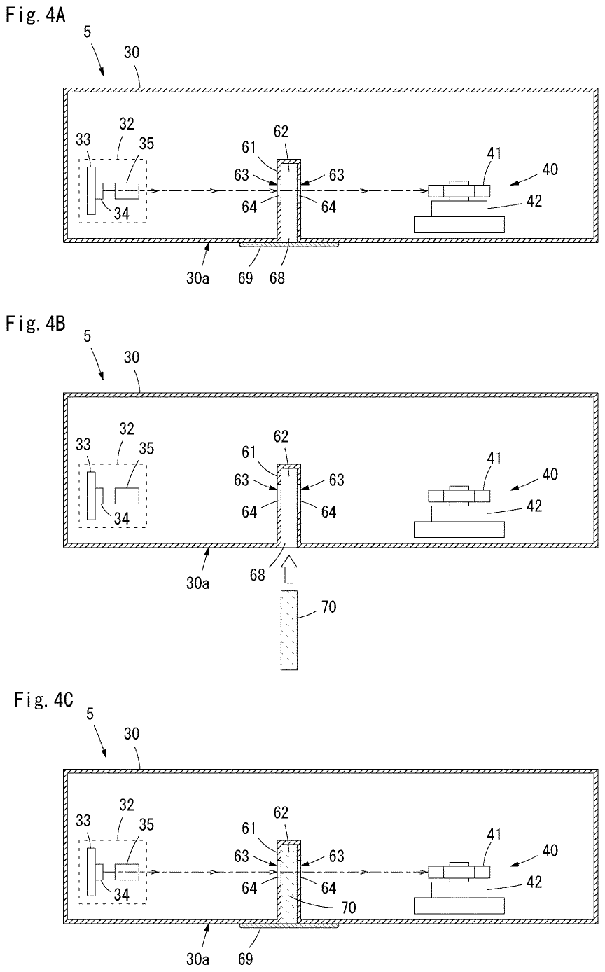

FIGS. 4A, 4B, and 4C are diagrams schematically illustrating optical paths from the light source 34 to the scanning member 40 inside the casing 30. As illustrated in FIG. 4A, the partition wall 61 erected on the inner side of the casing 30 is formed in an optical path from the light source 34 to the scanning member 40. The light that has passed through the scanning member 40 is converted by the polygon mirror 41 into light that scans a wide area. Therefore, when the light after passing through the scanning member 40 is configured to pass through the external space, it is necessary to form the partition wall 61 erected inside the casing 30 in a wide range along the main scanning direction F3. In contrast, a region through which light passes is narrow in an optical path from the light source 34 to the scanning member 40. Therefore, by forming the partition wall 61 in the optical path between the light source 34 and the scanning member 40, there is an advantage that a region where the partition wall 61 is formed can be reduced.

As illustrated in FIG. 4A, the partition wall 61 has an opening window 63 through which the light from the light source 34 passes, and a transparent member 64 such as a glass plate is attached to the opening window 63. The light emitted from the light source 34 travels from the internal space 31 of the casing 30 to the external space 62 through the transparent member 64 provided in the partition wall 61, and further travels from the external space 62 to the internal space 31 of the casing 30 again through the transparent member 64 provided in the partition wall 61. Therefore, the external space 62 is completely isolated from the internal space 31 of the casing 30 by the partition wall 61 and the transparent member 64.

Further, as shown in FIG. 4A, an opening 68 formed in the bottom 30a of the casing 30 is provided below the external space 62 surrounded by the partition wall 61. The external space 62 communicates with a space outside the casing 30 via the opening 68. However, when toner powder, paper dust, or the like enters the external space 62 surrounded by the partition wall 61, exposure by the optical scanning device 5 is affected. For this reason, a sealing member 69 is disposed in the opening 68 provided in the lower portion of the external space 62 as shown in FIG. 4A, and the opening 68 is closed so that the toner powder, the paper dust, or the like does not enter the external space 62. That is, when the optical scanning device 5 is attached to the image forming apparatus 1 and the image forming apparatus 1 is powered on, the sealing member 69 seals the external space 62. Therefore, even if a job is executed in the image forming apparatus 1 and toner powder or paper dust flies inside the image forming apparatus 1, the toner powder or the paper dust does not enter the external space 62.

For example, when the optical scanning device 5 is mounted on the image forming apparatus 1 having a high processing speed, nothing is inserted into the external space 62. Therefore, the light emitted from the light source 34 is not attenuated by passing through the external space 62. Therefore, the light emitted from the light source 34 can appropriately expose the photoreceptor 25 rotating at a high speed.

When the optical scanning device 5 is detached from the image forming apparatus 1, the sealing member 69 sealing the external space 62 can be removed as illustrated in FIG. 4B. When the sealing member 69 is removed, the external space 62 surrounded by the partition wall 61 communicates with the outside of the casing 30 via the opening 68. Therefore, as shown in FIG. 4B, an optical member (light amount adjuster) 70 can be inserted into the external space 62 through the opening 68.

For example, in a case where the optical scanning device 5 is mounted on the image forming apparatus 1 having a low processing speed, the optical member 70 is inserted into the external space 62 as illustrated in FIG. 4B. For example, the optical member 70 has a plate shape and is inserted perpendicularly to the optical path of the light passing through the external space 62. The optical member 70 is a member that reduces the amount of light emitted from the light source 34, and an optical member having an optimum light amount reduction rate corresponding to the processing speed of the image forming apparatus 1 is used. For example, in a case where a plurality of members having different light amount reduction rates are prepared as the optical member 70, the optical member 70 that is optimum for the processing speed of the image forming apparatus 1 in which the optical scanning device 5 is mounted is selected and inserted and mounted in the external space 62.

When the optical member 70 is inserted and mounted in the external space 62, a portion of the optical member 70 that is not irradiated with light from the light source 34 is preferably fixed to the inner side of the partition wall 61 with an adhesive or the like. Provided that the member for fixing the optical member 70 is not limited to the adhesive. For example, a plate spring or the like may be used to press and fix the optical member 70, or an engagement portion that engages with the optical member 70 may be used to fix the optical member 70 in the external space 62.

The external space 62 into which the optical member 70 is inserted is isolated from the internal space 31 of the casing 30. Therefore, when the optical member 70 is inserted and mounted in the external space 62, it is not necessary to open the casing 30. That is, work in a clean room is not required for the mounting work of the optical member 70. Therefore, the optical member 70 can be easily attached to the optical scanning device 5 without using a clean room.

When the optical member 70 is inserted into the external space 62, the sealing member 69 for closing the opening 68 of the external space 62 is attached again as shown in FIG. 4C. Thus, it is possible to prevent toner powder and paper dust from adhering to the optical member 70 and the like. Then, the optical scanning device 5 is attached to the image forming apparatus 1.

In the optical scanning device 5 attached to the image forming apparatus 1 in the state illustrated in FIG. 4C, when the light source 34 are turned on, the light emitted from the light source 34 passes through the external space 62. At this time, the amount of light from the light source 34 is reduced by passing through the optical member 70. Next, the light whose light amount has decreased is converted into light that scans in the main scanning direction F3 by the scanning member 40, and exposes the photoreceptor 25. That is, when the optical scanning device 5 used in the image forming apparatus 1 having a high processing speed is used in the image forming apparatus 1 having a low processing speed, the optical member 70 is inserted and mounted in the external space 62, so that the photoreceptor 25 can be appropriately exposed.

### Detection Sensor 6 and Controller 7

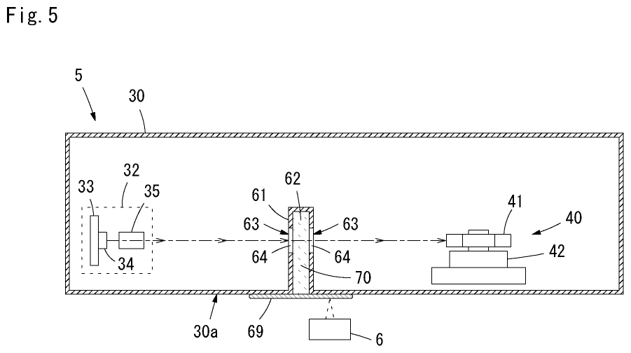

The optical scanning device 5 as described above can be attached to the printer unit 4 of the image forming apparatus 1 even in a state where the sealing member 69 is not attached. However, when the image forming apparatus 1 executes a job in a state where the sealing member 69 is not attached, toner powder and paper dust may scatter and enter the external space 62. Then, there is a possibility that the toner powder or the paper dust adheres to the optical path from the light source 34 to the scanning member 40. Therefore, as shown in FIG. 5, the image forming apparatus 1 is provided with a detection sensor 6 that is close to the mounting position of the optical scanning device 5 in the printer unit 4. The detection sensor 6 is a sensor that detects whether or not the sealing member 69 is attached to the opening 68 formed in the bottom 30a of the optical scanning device 5. For example, the detection sensor 6 is formed by a reflective optical sensor. In this case, the detection sensor 6 emits light toward the bottom 30a of the casing 30, and detects whether or not the sealing member 69 is attached based on the amount of received reflected light. A detection result by the detection sensor 6 is output to the controller 7.

When it is detected by the detection sensor 6 that the sealing member 69 is not attached to the opening 68, the controller 7 does not drive the optical scanning device 5. That is, when the sealing member 69 is not attached to the optical scanning device 5, the controller 7 prohibits execution of a job in the image forming apparatus 1.

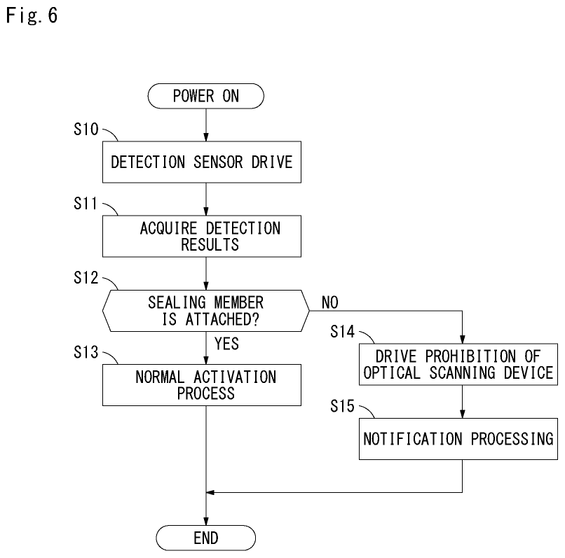

FIG. 6 is a flowchart illustrating an example of a processing procedure by the controller 7. This processing is executed by the controller 7 immediately after the image forming apparatus 1 is turned on and power supply to the image forming apparatus 1 is started. When the power supply is started, the controller 7 drives the detection sensor 6 and causes the detection sensor 6 to perform a process of detecting whether or not the sealing member 69 is attached to the optical scanning device 5 (step S10). Next, the controller 7 acquires the result of detection by the detection sensor 6 (step S11).

The controller 7 determines whether or not the sealing member 69 is attached to a predetermined position of the optical scanning device 5 based on the detection result by the detection sensor 6 (step S12). If the sealing member 69 is attached (YES in step S12), the controller 7 executes a normal activation process in the image forming apparatus 1 (step S13). By this activation processing, the image forming apparatus 1 is activated to a state in which a job can be executed.

In contrast, when the sealing member 69 is not attached (NO in step S12), the controller 7 prohibits driving of the optical scanning device 5 (step S14). Thus, the light source 34 and the scanning member 40 mounted in the optical scanning device 5 are not driven. In addition, since the optical scanning device 5 is not driven, the image forming apparatus 1 is brought into a state where execution of a job is prohibited.

Upon prohibiting driving of the optical scanning device 5, the controller 7 executes notification processing for providing notification that the opening 68 of the optical scanning device 5 is not closed (step S15). For example, the controller 7 provides notification by displaying, on the display part of the operation panel 3, a message indicating that the opening 68 of the optical scanning device 5 is not closed. Furthermore, the controller 7 may provide notification that execution of a job is prohibited. Furthermore, the controller 7 may provide notification that the opening 68 of the optical scanning device 5 is not closed, by sound or an alarm.

When the notification processing (step S15) is performed, the controller 7 does not perform the normal activation processing. Therefore, the image forming apparatus 1 is not activated to a state in which a job can be executed. Accordingly, it is possible to prevent a job from being executed in the image forming apparatus 1 in a state in which the sealing member 69 is not attached to the optical scanning device 5. As a result, it is possible to prevent dust such as toner powder and paper dust from entering the external space 62 of the optical scanning device 5.

As described above, the optical scanning device 5 of the present embodiment has a configuration in which the light emitted from the light source 34 passes through the external space 62 isolated from the internal space 31 of the casing 30, and the light is made incident on the internal space 31 of the casing 30 again from the external space 62 to be guided to the scanning member 40. In addition, an optical member 70 for adjusting the amount of light emitted from the light source 34 can be removably inserted into the external space 62 of the optical scanning device 5. The optical scanning device 5 having such a configuration can appropriately adjust the amount of light when exposing the photoreceptor 25 by disposing the optical member 70 in the external space 62 or removing the optical member 70 from the external space 62 according to the processing speed of the image forming apparatus 1 to which the optical scanning device 5 is attached.

The external space 62 is isolated from the internal space 31 of the casing 30. Therefore, it is not necessary to use a clean room when the optical member 70 is inserted into and removed from the external space 62. Therefore, the optical scanning device 5 has a configuration in which the optical member 70 can be inserted and removed with simple work.

Furthermore, since the optical scanning device 5 according to the present embodiment does not require a slidable transmittance adjustment element, a solenoid, or the like to be mounted in the internal space 31 of the casing 30, the device configuration does not become complicated, and increase in the size and cost of the device can be suppressed.

### Modification Example

A preferred embodiment of the present invention has been described above. However, the present invention is not limited to the content described in the above embodiment, and various modification examples are applicable.

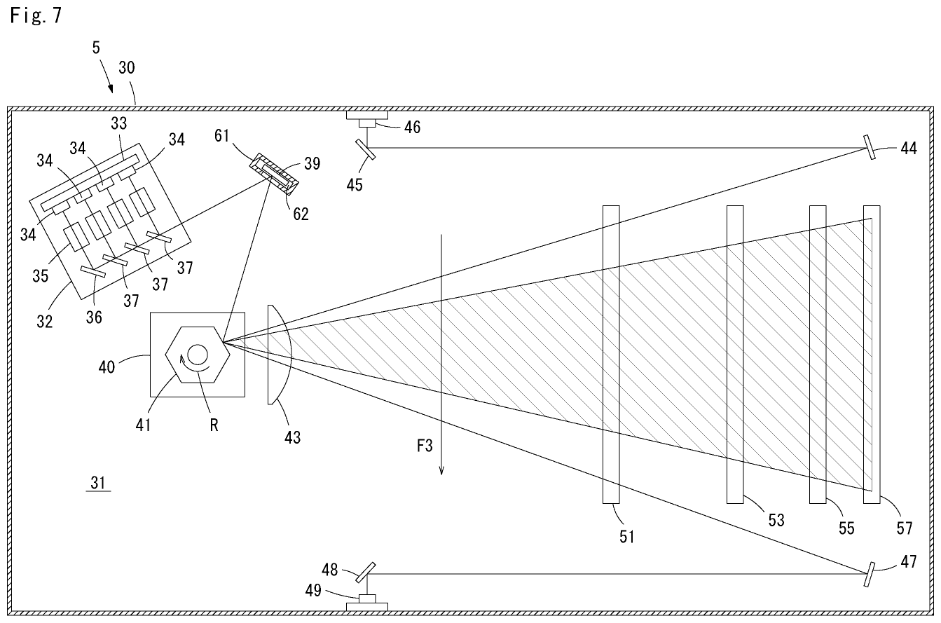

For example, FIG. 7 is a plan view illustrating a modification example of the optical scanning device 5. In the optical scanning device 5 illustrated in FIG. 7, the mirror 39 that reflects the light emitted from the light source 34 toward the scanning member 40 is disposed in the external space 62 isolated by the partition wall 61. Therefore, in the optical scanning device 5, the mirror 39 can be easily replaced according to the processing speed of the image forming apparatus 1. For example, in the case of the image forming apparatus 1 having a high processing speed, the mirror 39 having a high reflectance is disposed in the external space 62. Furthermore, in the case of the image forming apparatus 1 having a low processing speed, the mirror 39 having a low reflectance is arranged in the external space 62. Therefore, the configuration of the optical scanning device 5 shown in FIG. 7 may be adopted.

In the above embodiment, the case where the opening 68 of the external space 62 is provided in the bottom 30a of the casing 30 has been exemplified. However, the opening 68 may be formed at the outer surface of the casing 30, and is not necessarily limited to be provided in the bottom 30a. However, if the opening 68 of the external space 62 is provided in the bottom 30a of the casing 30, there is an advantage that the entry of dust can be minimized.

Further, the sealing member 69 described in the above embodiment may be a lid member capable of opening and closing the opening 68. Alternatively, the sealing member 69 may be an adhesive sheet to be attached to the outer surface of the casing 30.

Although embodiments of the present invention have been described and illustrated in detail, the disclosed embodiments are made for purposes of illustration and example only and not limitation. The scope of the present invention should be interpreted by terms of the appended claims.

What is claimed is

1. An optical scanning device, comprising:
a casing that seals an inside thereof;
a light source provided inside the casing; and
an optical scanner that is provided inside the casing and scans the light emitted from the light source, wherein
the light emitted from the light source passes through an external space of the casing, and the light entering the inside of the casing again from the external space is guided to the optical scanner.

2. The optical scanning device according to claim 1, wherein
the external space is formed by a partition wall erected inside the casing, and is isolated from an internal space of the casing.

3. The optical scanning device according to claim 2, wherein
a light amount adjuster is disposed in the external space and adjusts an amount of light emitted from the light source.

4. The optical scanning device according to claim 2, wherein
the partition wall includes an opening window provided in an optical path of the light emitted from the light source, and a transparent member attached to the opening window.

5. The optical scanning device according to claim 4, wherein
a light amount adjuster that adjusts the amount of light emitted from the light source can be inserted into and removed from the external space.

6. The optical scanning device according to claim 5, wherein
the light amount adjuster is a member that reduces the amount of light.

7. The optical scanning device according to claim 5, wherein
the external space communicates with the outside of the casing through an opening formed in an outer surface of the casing, and the light amount adjuster can be inserted and removed through the opening.

8. The optical scanning device according to claim 7, further comprising:
a sealing member that closes the opening and seals the external space.

9. The optical scanning device according to claim 7, wherein
the opening is formed in a bottom of the casing.

10. An image forming apparatuses, comprising:
the optical scanning device according to claim 1, wherein
the light source and the optical scanner are driven to form an image.

11. The image forming apparatuses, comprising:
the optical scanning device according to claim 8;
a controller that controls an operation of forming an image by driving the light source and the optical scanner; and
a sensor that detects whether or not the sealing member is provided in the opening, wherein
the controller does not drive the light source and the optical scanner when the sensor detects that the sealing member is not provided in the opening.

12. The image forming apparatus according to claim 11, wherein
the controller notifies that the opening is not closed when the sensor detects that the sealing member is not provided in the opening.
